(19) United States
(12) Patent Application Publication
(10) Pub. No.: US 2014/0140698 A1
(43) Pub. Date: May 22, 2014

(54) FIBER COAX UNIT (FCU) ARCHITECTURE FOR ETHERNET PASSIVE OPTICAL NETWORK (EPON) PROTOCOL OVER COAX (EPOC)

(71) Applicant: ZTE Portugal-Projectos de Telecomunicacoes Unipessoal Lda, Lisbon (PT)

(72) Inventor: Marek Hajduczenia, Fiaes (PT)

(21) Appl. No.: 14/080,742

(22) Filed: Nov. 14, 2013

Related U.S. Application Data
(60) Provisional application No. 61/726,794, filed on Nov. 15, 2012.

(51) Int. Cl. H04B 10/27

(52) U.S. Cl. CPC H04B 10/27
USPC 398/58

(57) ABSTRACT

Data connectivity is achieved at a transition between a first network that uses a first medium access control (MAC) protocol for data communication over a first type of physical medium and a second network that uses a second MAC protocol for data communication over a second type of physical medium. A combination apparatus provides a plurality of MAC instances on both the first network side and the second network side. The MAC instances on the first network side and the second network side are logically paired with each other during device discovery process on the network. The logical pairing is used to selectively provide data received at the first network interface to a MAC instance on the second network side and vice versa. Example implementations include a fiber coax unit providing connectivity between a Ethernet passive optical network (EPON) and an Ethernet Protocol over Coaxial Cable (EPoC) network.

### CROSS-REFERENCE TO RELATED APPLICATIONS

This patent document claims the benefit of priority of U.S. Provisional Patent Application No. 61/726,794, filed on Nov. 15, 2012. The entire content of the before-mentioned patent application is incorporated by reference herein.

### BACKGROUND

This document relates to data communications in Ethernet Passive Optical Network (EPON) and EPON Protocol over Coax (EPoC) networks.

Fiber networks can provide broadband communication services to user premises. Some network operators, e.g., hybrid fiber-coaxial cable (HFC) operators, have begun using fiber optic networks to increase bandwidth capacity of the physical medium used to carry data in their networks. However, due to regulatory requirements or capital expenditure reasons, an all-fiber network often terminates at a hybrid fiber coax (HFC) network, which in turn provides entry into user premises.

### SUMMARY

The present document discloses achieving seamless data connectivity at a transition between a first network that uses a first medium access control (MAC) protocol for data communication over a first type of physical medium and a second network that uses a second MAC protocol for data communication over a second type of physical medium. In some disclosed embodiments, a combination apparatus provides a plurality of MAC instances on both the first network side and the second network side. The MAC instances on the first network side and the second network side are logically paired with each other during device discovery process on the network. The logical pairing is used to selectively provide data received at the first network interface to a MAC instance on the second network side and vice versa.

In particular, the present document discloses a fiber coax unit (FCU) that enables the carriage of Ethernet protocol data traffic over a coaxial network. The disclosed embodiments can be useful in multiple ways in providing high bandwidth data from a network to customer premises, including improving bandwidth used both in the uplink (customer premises to network) and the downlink (network to customer premises) directions. The disclosed techniques can reduce both operational expenses and capital expenses for carrying Ethernet protocol data over coax by selectively re-using certain architectural building blocks of the Ethernet passive optical network (EPON) framework. The disclosed techniques can also be deployed in current EPON networks or DPoE (DOCSIS provisioning of EPON) networks with little or no changes to existing equipment.

In one exemplary aspect, a Fiber Coax Unit (FCU) platform is disclosed. The FCU provides an Ethernet Passive Optical Network (EPON) interface to an EPON network and an Ethernet Protocol Over Cable (EPoC) interface to a cable network. A first data traffic is received and transmitted over the EPON interface using a plurality of optical network unit (ONU) media access control (MAC) protocol stack instances. A second data traffic is received and transmitted over the EPoC interface using a plurality of Coax Line Terminal (CLT) protocol stack instances. An FCU mediation layer selectively transfers portions of data from the first data traffic to the plurality of CLT protocol stack instances and the second data traffic to the plurality of OLT protocol stack instances. In some implementations, the FCU mediation layer directs a received operation, administration and maintenance (OAM) or extended OAM (eOAM) message from the EPON interface towards an associated CLT MAC protocol stack instance. In some implementations, the FCU mediation layer directs a received operation, administration and maintenance (OAM) or extended OAM (eOAM) message from the EPoC interface towards an associated ONU MAC protocol stack instance. In some implementations, the FCU selectively routes data between the first data traffic and the second data traffic based on association information created between a source EPON node and a destination EPoC node associated with the data during discovery and registration of a new cable network unit (CNU). In some embodiments, the FCU creates the association information by first creating a logical pair between an EPON MAC stack and an EPoC MAC stack based on their corresponding MAC addresses, obtaining a first logical link identifier by registering the paired EPON MAC stack in the EPON network, obtaining a second logical link identifier by registering the paired EPoC MAC stack in the EPoC network, and updating the logical pair with the first and the second logical link identifiers.

In another exemplary aspect, a process of operating a fiber cable unit (FCU) to provide data connectivity between an EPON that uses optical fiber as a first physical medium for communication and an Ethernet protocol over coax network that uses coaxial cable as a second physical medium for data communication is disclosed.

In yet another exemplary aspect, the disclosed techniques for selective data transmission between a plurality of EPON MAC stacks and a plurality of EPoC MAC stacks can be stored as executable instructions in a memory and a processor can read and execute the stored instructions to implement the disclosed techniques.

These and other aspects, and their implementations and variations are set forth in the drawings, the description and the claims.

### BRIEF DESCRIPTION OF THE DRAWINGS

FIG. 1A illustrates various deployment scenarios for a fiber coax unit.

FIG. 1B is an architectural block diagram of a combined fiber and coax cable data network.

FIG. 2 is an architectural block diagram of a network that includes a fiber cable unit (FCU).

FIG. 3 depicts functional blocks of a fiber cable unit.

FIG. 4 is a flow chart representation of a process of operating an FCU.

FIG. 5 is a block diagram representation of a fiber coaxial cable unit.

Like reference symbols in the various drawings indicate like elements.

### DETAILED DESCRIPTION

The present document relates to systems, devices and techniques for data communications in an Ethernet Passive Optical Network (EPON) and EPON Protocol over Coax (EPoC), and specifically to the architecture of the Fiber Coax Unit (FCU). Recently, CableLabs has issued Data Over Cable System Information Specification (DOCSIS) Provisioning of EPON (DPoE) architecture specifications versions 1 and 2. However, several features and operational details of the FCU, which can be used within the general framework of DPoE, have not been specified. The present document identifies certain functions of the FTU, which represents the functional block at which fiber ends and coaxial network begins, and several possible implementation options for implementing the FCU. Furthermore, this document also discloses a common management platform that can be used to implement the FCU functionality and changes to the DPoE architecture useful to support EPoC Coax Line Terminal (CLT) and Coax Network Unit (CNU) devices via the common management platform.

EPON Protocol over Coax (EPoC) reuses Ethernet Passive Optical Network (EPON) protocols for operation over coaxial (passive and amplified) access networks, while maintaining the same operating principles of EPON. In particular, EPoC reuses the operating principles and scheduling facilities provided by the Multi Point Control Protocol (MPCP) specified for EPON in IEEE Std 802.3.

The evolution of cable networks to all-IP-based service delivery is driven by the flexibility and ubiquity provided by IP connectivity as well as several market forces and trends, e.g., as disclosed in the present document.

The new IP-based services and applications can be delivered more efficiently if the underlying architecture natively supports IP transport without having to reuse non-IP-optimized transport architectures.

The proliferation of handheld and tablet devices that provide wireless connectivity significantly has increased the consumer demands of access to entertainment contents anywhere, at any time.

There is interest in cable operators for delivering managed subscription-based video services over IP end-to-end, replacing today's Motion Picture Experts Group—Transport Streams (MPEG-TS) delivery over the HFC access network. IP-based delivery of managed video services enables operator-managed video services to reach “any device, any time, any place,” which is essential for cable operators to maintain competitiveness as various over-the-top video sources flood the marketplace.

Several new revenue opportunities are made available by IP. For example, using IP allows wider reach of ads and expands the opportunities for ad placements.

The exponential increase in the demand to deliver video content, not only over the public Internet, but also for subscribed IPTV services to set-tops, mobile devices and laptops has also lead to an increased demand on IP connectivity.

A key challenge facing multiple system operators (MSOs) to migrate to an all-IP network is the astronomical increase in bandwidth required to deliver real-time entertainment over IP networks. EPoC is expected to address this problem in the most economic fashion, primarily through the internetworking with EPON/DPoE Systems.

Once developed, EPoC will support a number of deployment scenarios, with varied degrees of fiber penetration. The variable fiber penetration depth caters best to existing cable operator networks, requiring little or no changes at all to the existing cable plant.

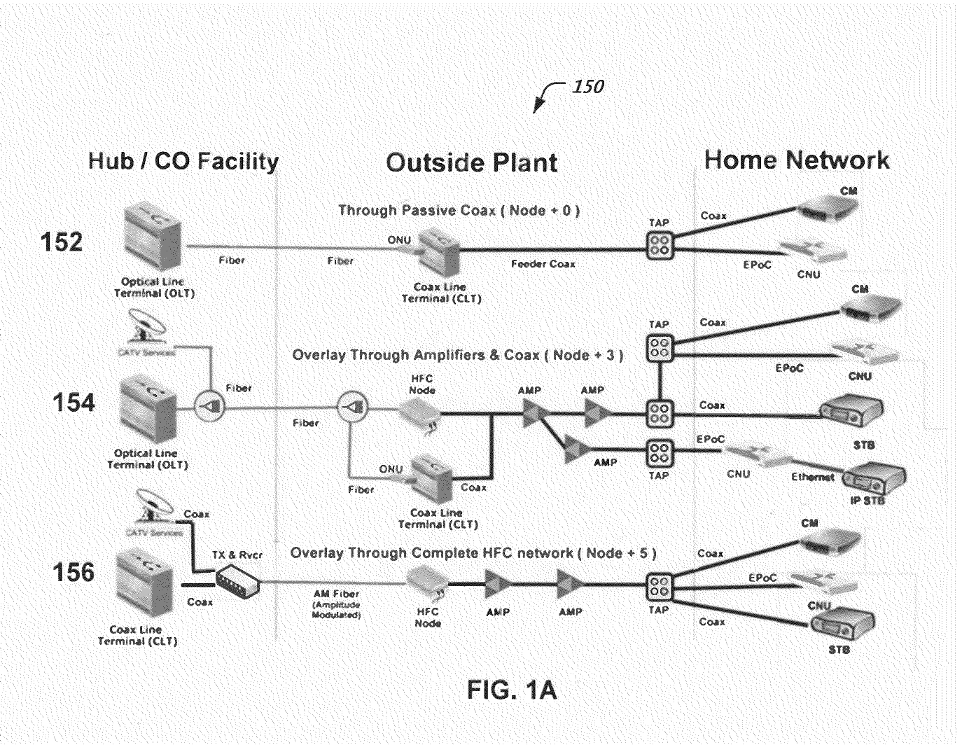

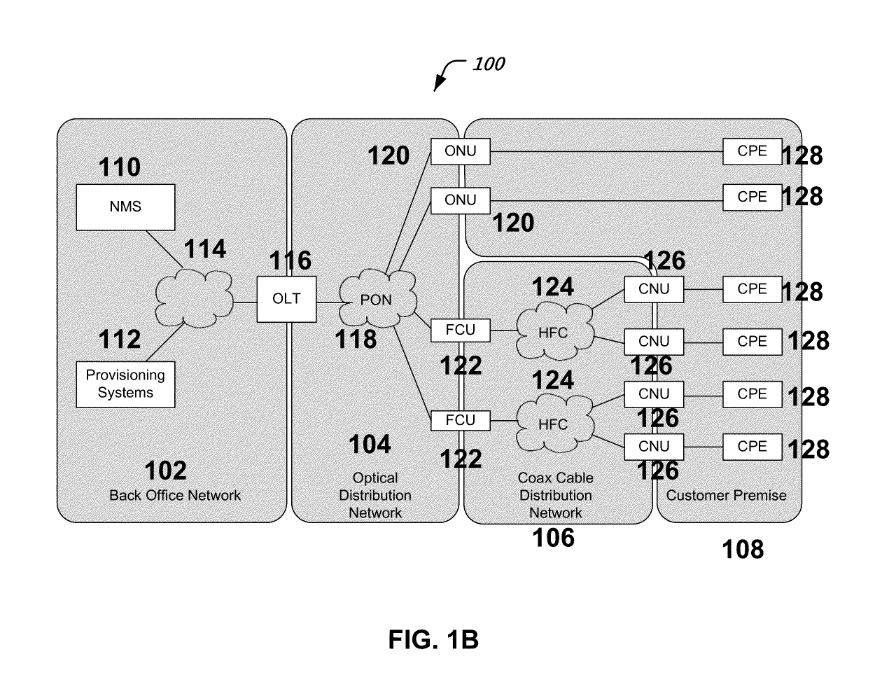

With reference to FIG. 1A, example deployment scenarios (collectively 150) are discussed in more detail below.

In the first scenario 152 shown in FIG. 1A, EPoC is deployed as a direct (and transparent) extension of EPON for operation over coaxial outside plant. In this case, EPON is using a data backhauling technology, carrying digital data to and from the CLT deployed in field, potentially in the location of the current FN, and the CLT is used to drive the coaxial plant deployed in Node+0 architecture, providing services to CNUs replacing some or all of the existing CMs (cable modems). This deployment option is shown in more detail in the second scenario 154, where CLT is deployed side-by-side the HFC node. In both the first and second scenarios, a properly selected spectrum allocation plan for both EPoC and DOCSIS is needed to guarantee that various types of devices connected to the same coaxial plant can operate seamlessly. Considering additional analog and digital video distribution services in this scenario makes the spectrum allocation plan even more challenging.

The third scenario 156 shows a direct migration from an existing DOCSIS based cable plant to EPoC, where analog fiber is used for backhauling and FN displacement purposes, reaching the network diameters currently supported by the DOCSIS networks.

Given that these are just examples of future EPoC deployment scenarios, it is clear that this technology has an evolutionary potential in part based on its ability to coexist with both DOCSIS and EPON/DPoE, the ability to operate on its own, and the ability of reusing the existing coaxial plant with changes to electronic endpoints only. Taking advantage of certain available coaxial and fiber technologies, it is likely to help with the adoption of FTTx in cable networks, making Fiber to the Node architecture more popular. Eventually, the proximity of the fiber node to the customer as well as availability of EPON/DPoE equipment in the headend will facilitate the path of migration toward fiber-oriented services for both business and residential customers.

FIG. 1B discloses an example combined optical and hybrid fiber coaxial network 100. The logical partitions include a backoffice network 102, an optical distribution network 104, a coaxial cable distribution network 106 and customer premises 108. The backoffice network 102 includes a provisioning system 112 and a network management server 110 connected to an optical line terminal (OLT) 116 over a backoffice network could 114. The OLT 116 is communicatively coupled to a passive optical network PON 118, which in turn is connected to multiple optical network units (ONUs) 120 and fiber cable units (FCU) 122. The ONUs 120 may couple to the customer premises equipment CPE 128 over an optical fiber link. The FCU 122 may be connected to CPE 128 over a cable link via hybrid fiber coax network 124 and cable network units 126.

In various embodiments, an FCU 122 may include some of the following functional features.

An FCU may inter-connect fiber (EPON) and coax (EPoC) distribution domains, acting as a media converter between both domains (ODN=optical distribution network, CDN=coaxial distribution network) operating with different media, as well as with different data rates.

An FCU in the downstream direction (from the OLT towards the CNU) may filter packets not intended for any of CNUs connected to the given FCU, lowering bandwidth demand on CDN in the downstream direction. This particular functional requirement may not affect the upstream transmission direction in any way.

An FCU in the upstream direction aggregates transmissions from individual CNUs and makes them available to the OLT in a way that isolates the OLT from having to learn CDN parameters, be able to cope with dynamically changing and variable data rates for individual CNUs as well as having to distinguish CNUs from ONUs in terms of scheduling.

An FCU may allow the OLT to perform scheduling for individual ONUs and CNUs in the same fashion, without requiring any changes in the existing DPoE/EPON implementations.

An FCU may be reachable via OAM, eOAM and MPCP for remote control from the OLT perspective and may be seen from the OLT perspective as an EPON ONU (for all bandwidth control and management purposes).

The DPoE specifications describe a network architecture allowing EPON ONUs to be configured and managed using the cable operator's existing back office servers. Furthermore, the same provisioning concepts such as DHCP, TFTP, and configuration files are imposed on DPoE ONUs and DPoE Systems such that an access network based on EPON technology resembles a DOCSIS access network from the perspective of the cable operators back office servers.

In order to take full advantage of the existing DPoE management model covered in detail in DPoE specifications, the FCU in some implementations can be configured to reuse the concept of virtual Cable Modem (vCM) instantiated in the OLT (DPoE System in DPoE-specific terminology), which is used to provide IP-based management functions for a remote subscriber station reachable via a combination of OAM and eOAM specified by IEEE 802.3, IEEE 1904.1 and CableLabs in conjunction.

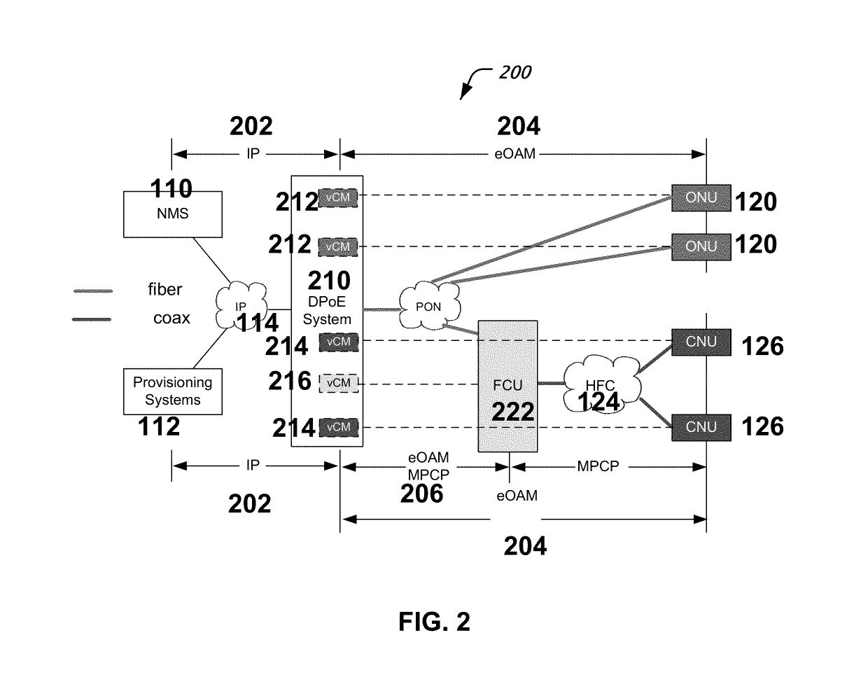

FIG. 2 shows an example of extension to the DPoE Network architecture 200, where the vCM-based management concept is extended to both the FCU and CNUs subtended to the FCU, making each subscriber station look exactly the same at the OLT level. A dedicated vCM is therefore instantiated to manage the FCU (yellow vCM instance in FIG. 2, 216), and each newly discovered and registered CNU is also allocated a dedicated vCM on the OLT (red vCM instances in FIG. 2, 214).

As shown in FIG. 2, the OLT uses OAM and eOAM for management of the FCU and CNUs, relying on the translation between the DOCSIS OSS management system messages and the EPON/EPoC specific messages provided by the vCM. In this management model, from the perspective of the OSS and DPOE system, the FCU and CNUs are considered to be a special type of EPON ONU, with specific bandwidth restrictions in downstream and upstream direction.

In such an arrangement, the existing DPoE DEMARC specifications, defining the operation of a DEMARC Auto Configuration (DAC) protocol, can be extended in a transparent manner into EPON+EPoC Network management model shown in FIG. 2, where DEMARC could be connected to any interface on the CNU. Such an arrangement would require the CNU to meet all of the requirements for DPoE ONU listed in the DPoE-SP-DEMARC specification, including the support for LLDP agents on the MI interface(s). However, from a management perspective there is no difference between a DEMARC connected to a DPoE ONU and a DEMARC connected to CNU, when looking from the OLT perspective (excluding, perhaps, the available bandwidth for services).

Furthermore, the whole service provisioning and QoS model employed in DPoE and defined in DPoE-SP-MEF and DPoE-SP-MULPI (versions 1 and 2, as published by CableLabs) can be also extended to CNUs across the FCU, given that the required management traffic (OAM, eOAM) and subscriber traffic is passed transparently, while QoS enforcement in the EPON remains unchanged from what was defined in DPoE.

In FIG. 2, the IP domain and the eOAM domain are shown as 202 and 204 respectively. The vCM instances 212 are logically paired with the corresponding ONUs 120. The eOAM PCP 206 extends between the DPoE system 210 and the FCU 222 (which could be substantially similar to FCU 122).

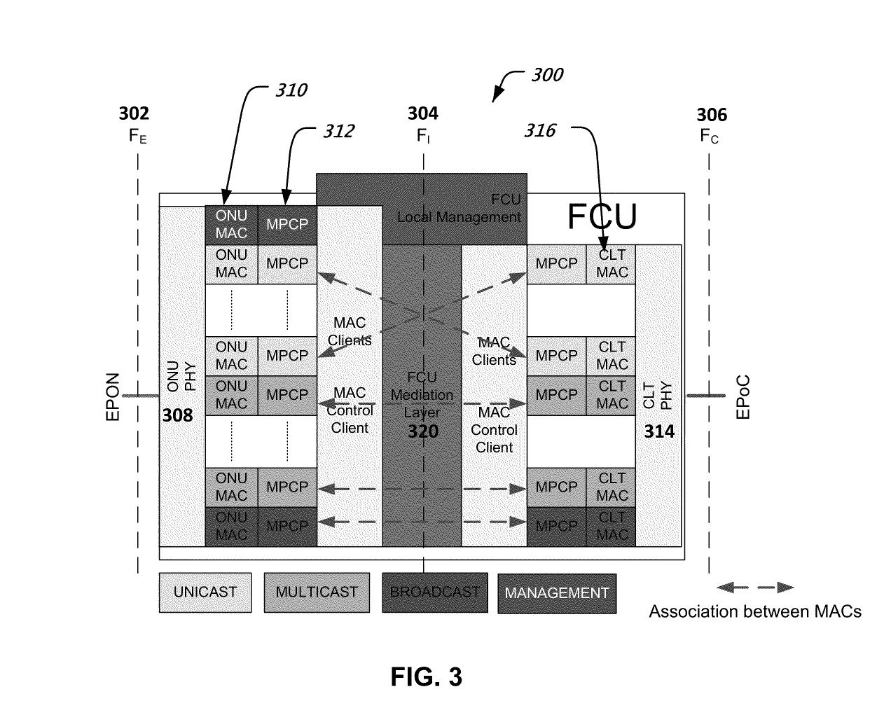

With reference to FIG. 3, an embodiment of an FCU 300 is depicted. The FCU 300 includes a bridge function and a repeater function, where frames intended to be forwarded to selected CNUs (unicast traffic), selected group of CNUs (multicast traffic) or all CNUs (broadcast traffic) subtended at the given FCU are filtered accordingly (e.g., based on the combination of link layer identifier LLID and destination MAC address) and then forwarded to the proper MAC instances in the FCU on the side of the HFC network (at the F_{C} interface). Any multicast or unicast frames not addressed to any of the CNUs subtended to the given FCU are filtered out and dropped at the F_{E} interface, lowering therefore the bandwidth requirements on the CDN, eliminating the need to carry traffic that would be dropped by the CNUs anyway.

On the EPON side (at the F_{E} interface 302), the FCU is equipped with an ONU-like PHY 308, capable of continuous-mode downstream operation and burst-mode upstream operation, combined with a number of MAC instances 310: at least one unicast MAC instance, at least one multicast instance and exactly one broadcast MAC instance. Each MAC instance is associated with an LLID upon discovery and registration of the associated MAC instance at the OLT, following the provisions of the IEEE Std 802.3, Clause 77 for 10G-EPON capable FCU or Clause 64 for 1G-EPON capable FCU. All unicast and multicast MAC instances on the EPON interface side.

Moreover, on the EPON side (at the F_{E} interface 302), the FCU is also equipped with one additional unicast MAC instance 310. This MAC instance is not associated with any CLT MAC instances and it is used exclusively for the local FCU management purposes.

Alternatively, the FCU at the F_{E} interface can be equipped with the P2P Ethernet interface when connected to a P2P Ethernet port on the DPoE System capable of supporting such a data link. The support for P2P data links is not currently accounted for by DPoE specifications, though a person skilled in art could extend the coverage from P2MP architecture of EPON to P2P Ethernet architecture. Different data rate P2P Ethernet interfaces can be supported, ranging from 1 Gbit/s Ethernet, through 10 Gbit/s Ethernet as well as higher speed Ethernet interfaces, if the FCU requires such backhaul capacity. The architectural framework for the FCU device included in this document can be adapted to P2P Ethernet backhaul link.

In case of the P2P Ethernet backhaul link between the OLT and the FCU, there is only one MAC instance at the FE interface, and the MPCP is replaced by a generalized MAC Control sublayer.

On the EPoC side (at the F_{C} interface), the FCU is equipped with a EPoC CLT PHY, capable of FDD or TDD mode operation (depending on the operator-driven configuration), combined with a number of MAC instances (marked as “CLT MAC” in FIG. 3): at least one unicast MAC instance, at least one multicast instance and exactly one broadcast MAC instance. Each CLT MAC instance is associated with an LLID upon discovery and registration of a new CNU device. The LLID associated at the F_{C} interface with the specific CNU is not known to the OLT (i.e., the OLT does not have scheduling visibility into the coaxial network between the CLT and CNU), and may be different than the LLID assigned at the F_{E} interface to the ONU MAC instance associated with the CLT MAC instance for the given CNU. The number of unicast CLT MAC instances matches 1 for 1 the number of unicast CNU MAC instances that are discovered and registered at the FCU. The number of multicast CLT MAC instances in physical devices is implementation dependent, limiting the practical number of CNUs that can be registered at any time at the FCU.

On the EPoC side (at the F_{C} interface), there is no dedicated unicast MAC instance for the local FCU management purposes.

On the EPON side (at the F_{E} interface), when equipped with the EPON backhaul interface, the unicast, multicast and broadcast ONU MAC instances are not equipped with the OAM Client and all OAM and eOAM packets received from the F_{E} interface are forwarded across the FML towards the associated CLT MAC instance. This means, effectively, that the OAM management domain spans between the OLT and the CNU, as shown in FIG. 3. Similar arrangement is used for the CLT MAC instances, which are not equipped with OAM Client instances, forwarding all OAM and eOAM packets received from the F_{C} interface are forwarded across the FML towards the associated ONU MAC instance.

The FCU Mediation Layer (FML) 320 presented within the FCU at the F_{I} interface 304 is primarily responsible for forwarding traffic between associated ONU MAC and CLT MAC instances, as well as performing additional scheduling, polling and mapping tasks for such MACs.

In some embodiments, the FML 320 forwards (acting as a repeater) downstream unicast, multicast or broadcast packets received from the EPON interface F_{E} towards the appropriate CLT MAC instance at the F_{C} interface. The forwarding decision is taken based on the association between the source (ONU) and destination (CLT) MAC created at the time of discovery and registration of a new CNU.

In some embodiments, the FML 320 forwards downstream management (OAM and eOAM) traffic received from the EPON interface F_{E} towards the appropriate CLT MAC instance at the F_{C} interface. The forwarding decision is taken based on the association between the source (ONU) and destination (CLT) MAC created at the time of discovery and registration of a new CNU.

In some embodiments, the FML 320 forwards upstream unicast and multicast packets received from the EPoC interface F_{C} towards the appropriate ONU MAC instance at the F_{E} interface. The forwarding decision is taken based on the association between the source (CLT) and destination (ONU) MAC created at the time of discovery and registration of a new CNU. In the upstream, all broadcast traffic may be constrained within the EPoC CDN.

In some embodiments, the FML 320 forwards upstream management (OAM and eOAM) traffic received from the EPoC interface F_{C} towards the appropriate ONU MAC instance at the F_{E} interface. The forwarding decision is taken based on the association between the source (CLT) and destination (ONU) MAC created at the time of discovery and registration of a new CNU. In the upstream direction, all broadcast traffic is constrained within the EPoC CDN.

In some embodiments, the FML 320 creates an association between the ONU MAC and CLT MAC instances at the time when a new CNU is discovered and registered at the CLT.

Any unicast or multicast downstream packets received from the EPoC interface F_{C} and not intended for any of the unicast or multicast ONU MAC instances may be dropped at the F_{E} interface, e.g., following the rules defined in IEEE Std 802.3, Clause 65 for 1G-EPON capable FCU and Clause 76 for 1G-EPON capable FCU. This means that only frames intended to be distributed within the given CDN subtended at the given FCU are forwarded by the FML and then handed off to the CLT for transmission in the FDD or TDD mode, as configured by the operator.

The process of creating an association between the ONU MAC and CLT MAC instance starts with the discovery of a new CNU MAC instance, at which time the CLT performs the CNU discovery and registration process, currently under definition in IEEE P802.3bn “EPoC” Task Force. During this process, the CLT binds also one local unicast CLT MAC instance with the newly discovered CNU MAC instance, creating an association between the allocated LLID, CNU MAC instance and the CLT MAC instance, required for the proper operation of the EPoC protocols.

After a successful registration of a new CNU MAC instance, the FML proceeds to create an association between the newly created CLT MAC instance and one of available (and currently inactive) ONU MAC instances. For simplicity, it is assumed that there is at least one inactive ONU MAC instance available for this process. In real devices, there may be a limited number of ONU MAC instances available for such an association, due to hardware limitations. The process of creating the association features three stages, outlined as follows.

In the first stage, an association is created between a currently inactive ONU MAC instance (MAC_{E}) and newly activated CLT MAC instance (MAC_{C}), where the association between these two MAC instances is based on the MAC address. In this stage, the MAC_{E} is not yet registered at the OLT and the only information that can be used to establish the association between MAC_{E} and MAC_{C} are their MAC addresses.

In the second stage of the process, the newly activated MAC_{E} is registered at the OLT following the process of MPCP discovery and registration defined in IEEE Std 802.3, Clause 77 for 10G-EPON capable FCU and Clause 64 for 1G-EPON capable FCU. At the end of this stage, the MAC_{E} is assigned EPON LLID (LLID_{E}) used to deliver all unicast data over EPON.

In the third stage of the process, the association between MAC_{E} and MAC_{C} is updated and the binding between two MAC instances is based on LLID value, i.e., LLID_{E} used within EPON ODN and the LLID_{C} used within EPoC CDN. There are no requirements towards the uniqueness of LLID_{E} and LLID_{C} values and they can be either the same or different. Both LLID domains in the proposed FCU architecture are isolated and can share the same LLID numbering space.

After the completion of the association process, traffic received across F_{E} interface and tagged with LLID_{E} is forwarded towards MAC_{C} instance associated with LLID_{C}, corresponding to LLID_{E}, based on the association between the ONU MAC instance at the F_{E} interface and the CLT MAC instance at the F_{C} interface, maintained within the FML. Below are three examples for data frames, OAM frames and MPCP frames transmitted downstream from the OLT and the CNU on unicast LLID_{E}, intended for CNU with MAC_{C} associated with LLID_{C}, bonded with LLID_{E}.

In the downstream direction, the FML 320 provides sufficient buffering for frames intended to be delivered to respective CNUs. Such frames may need to wait for availability of downstream transmission link to the destination CNU, especially when there is difference between the data rate supported by EPON and EPoC. Similar buffering space is provided in the upstream direction as well, for any frames intended to be delivered to the OLT. The upstream buffer size should additionally account for the scheduling delay, since the upstream channel within EPON may not become available immediately, given the shared medium operating mode in the upstream direction.

Any user data frame is transmitted downstream with the destination MAC address of the target CPE device, connected to the CNU, and with the LLID_{E}, indicating the unicast link between the OLT and FCU. All such frames are then forwarded towards the associated LLID_{C} across the FML and then delivered to the target CNU using the TDD or FDD mode, depending on the operator configuration.

Any OAM frame is transmitted downstream with the slow protocol multicast MAC address of 0x01-80-C2-00-00-02 and with the LLID_{E}, indicating the unicast link between the OLT and FCU. Given the absence of the OAM Client in FCU in downstream direction, all such frames are forwarded towards the associated LLID_{C} across the FML and then delivered to the target CNU using the TDD or FDD mode, depending on the operator configuration.

Any MPCP frame is transmitted downstream with the MAC Control multicast MAC address of 0x01-80-C2-00-00-01 and with the LLID_{E}, indicating the unicast link between the OLT and FCU. Given that the FCU in the downstream direction is equipped with the MAC Control Client instances, MPCP frames are locally sunk by the associated clients and not forwarded towards individual CNUs.

The transmission in the upstream direction is generally the same, with one difference being the additional queuing delay due to the operation of the shared-medium access protocol in the upstream channel of EPON.

It will be appreciated that using the disclosed techniques, bandwidth utilization on EPON can be optimized for fiber devices only and is not burdened with CNUs that typically do not operate at full fiber interface data rate.

Similarly, using the disclosed techniques, bandwidth utilization on EPoC can be optimized for coax devices, both in terms of grant design, frequency, size etc.

In one advantageous aspect, the FCU 320 performs a simple media conversion and a repeater-like operation of FCU for associated EPON-side and EPoC-side LLIDs, without extra scheduling complexity (and delay) to accommodate for coax and fiber devices on the same port.

Existing EPON OLTs (and DPoE System) hardware can be used with EPoC CNUs unmodified, preserving already existing investment, while FCUs can be added to the already existing DPoE Network deployments are any time and at any location, providing the ability to serve both residential and business customers off the same ODN.

Each EPoC LLID is mapped through FCU Mediation Layer (FML) into an EPON LLID, allowing EPON OLT to schedule them independently and individually, providing improved QoS.

EPoC can use either FDD or TDD, without affecting scheduling across EPON, constraining the problems related with implementation of both of these modes of operation to EPoC only

Discovery windows for EPON devices can be smaller, not having to account for presence of both fiber and coax devices on the same port.

Frames that have errors can be dropped at the FCU when an incorrect FCS is detected. Therefore, in some embodiments, the FCU can mitigate error propagation problem in which a frame is transmitted by one of CNUs and is corrupted during the transmission over CDN, but still consumes unnecessarily upstream resources in the EPON.

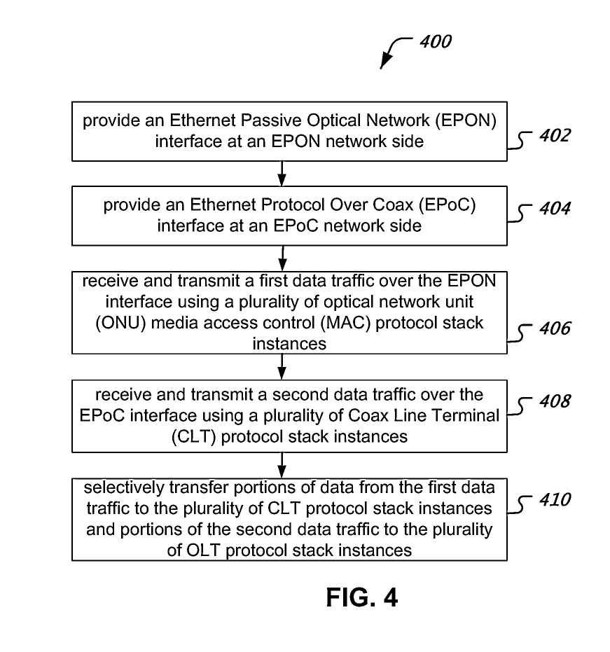

FIG. 4 is a flow chart representation of a process 400 for providing data connectivity between an EPON network and an EPoC network. At 402, an EPON interface is provided at an EPON network side. At 404, an EPoC interface is provided at an EPoC network side. At 406, a first data traffic is received and transmitted over the EPON interface using a plurality of optical network unit (ONU) MAC instances. At 408, a second data traffic is received and transmitted over the EPoC interface using a plurality of coax line terminal (CLT) MAC instances. At 410, portions of data from the first data traffic are selectively transferred to the plurality of CLT MAC instances and portions of the second data traffic are selectively transferred to the plurality of OLT MAC instances.

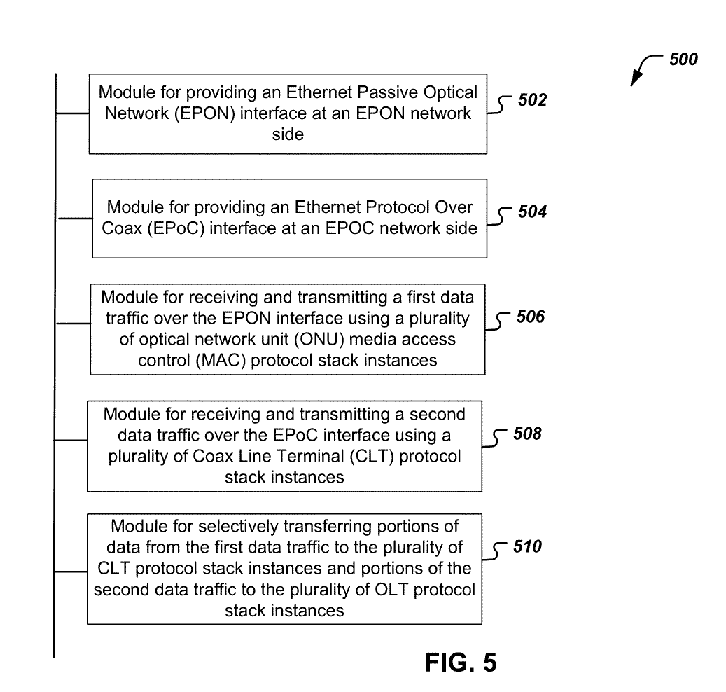

FIG. 5 is a block diagram representation of an apparatus 500 for EPoC data connectivity. The module 502 is for providing an Ethernet Passive Optical Network (EPON) interface at an EPON network side. The module 504 is for providing an Ethernet Protocol Over Coax (EPoC) interface at an EPoC network side. The module 506 is for receiving and transmitting a first data traffic over the EPON interface using a plurality of optical network unit (ONU) media access control (MAC) instances. The module 508 is for receiving and transmitting a second data traffic over the EPoC interface using a plurality of Coax Line Terminal (CLT) MAC instances. The module 510 is for selectively transferring portions of data from the first data traffic to the plurality of CLT protocol stack instances and portions of the second data traffic to the plurality of OLT protocol stack instances.

The disclosed and other embodiments and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. An apparatus for facilitating data connectivity between an Ethernet Passive Optical Network (EPON) and an Ethernet Protocol Over Coaxial Cable (EPoC) network, comprising:
means for providing an EPON interface on an EPON side;
means for providing an EPoC interface on an EPoC network side;
means for receiving and transmitting a first data traffic over the EPON interface using a plurality of optical network unit (ONU) medium access control (MAC) instances;
means for receiving and transmitting a second data traffic over the EPoC interface using a plurality of coaxial line terminal (CLT) medium access control (MAC) instances; and
means for selectively transferring portions of data from the first data traffic to the plurality of CLT MAC instances and portions of data from the second data traffic to the plurality of ONU MAC instances.

2. The apparatus recited in claim 1, wherein the plurality of ONU MAC instances includes a unicast ONU MAC instance, a multicast ONU MAC instance and a broadcast ONU MAC instance.

3. The apparatus recited in claim 2, further including:
means for associating the plurality of ONU MAC instances with a plurality of logical link identifiers (LLIDs) that are used for identifying data packets transferred over the EPON.

4. The apparatus recited in claim 1, wherein the plurality of CLT MAC instances includes a unicast CLT MAC instance, a multicast CLT MAC instance and a broadcast CLT MAC instance.

5. A method of providing data connectivity between a fiber optic network and a coaxial cable network, comprising:
discovering a cable medium access control (MAC) instance having a first MAC address;
associating a fiber optic network MAC instance having a second MAC address with the cable MAC instance;
assigning a first logical link identifier (LLID) to the fiber optic network MAC instance for addressability in the fiber optic network;
assigning a second logical link identifier (LLID) to the cable MAC instance for addressability in the cable network;
forming a logical pairing of the first LLID and the second LLID; and
selectively filtering data traffic between the fiber optics MAC instance and the cable MAC instance using the logical pairing and a type of data traffic.

6. The method recited in claim 5, wherein the first MAC address and the second MAC address are unicast MAC addresses.

7. The method recited in claim 5, wherein the first MAC address and the second MAC address are multicast MAC addresses.

8. The method of claim 5, further comprising:
passing through, without processing at the fiber optic MAC instance, data traffic comprising management messages received over the fiber optic network to the cable MAC instance.

9. The method of claim 5, wherein the selective filtering includes:
dropping, at an interface with the fiber optic network, data packets addressed to another cable MAC instance that is not subtended.

10. The method of claim 5, further comprising:
associating an additional MAC instance for local management purpose.

11. The method of claim 10, wherein the additional MAC message is only for local management at an interface to the fiber optic network.

12. An apparatus for providing data connectivity between a first network in which data is communicated over a first physical medium and a second network in which data is communicated over a second physical medium, the apparatus comprising:
a first network interface unit adapted to transmit and receive data over the first network, the first network interface unit comprising a first plurality of medium access control (MAC) instances;
a second network interface unit adapted to transmit and receive data over the first network, the first network interface unit comprising a first plurality of medium access control (MAC) instances; and
an emulation layer that selectively passes data traffic between the first network interface and the second network interface.

13. The apparatus recited in claim 12, wherein the plurality of ONU MAC instances includes a unicast ONU MAC instance, a multicast ONU MAC instance and a broadcast ONU MAC instance.

14. The apparatus recited in claim 13, further including:
a module that associates the plurality of ONU MAC instances with a plurality of logical link identifiers (LLIDs) that are used for identifying data packets transferred over the EPON.

15. The apparatus recited in claim 12, wherein the plurality of CLT MAC instances includes a unicast CLT MAC instance, a multicast CLT MAC instance and a broadcast CLT MAC instance.

16. A communications apparatus comprising:
a storage medium that stores instructions; and
a processor that reads the instructions from the storage medium and implements a method of providing data connectivity between a fiber optic network and a coaxial cable network, the method comprising:
discovering a cable medium access control (MAC) instance having a first MAC address;
associating a fiber optic network MAC instance having a second MAC address with the cable MAC instance;
assigning a first logical link identifier (LLID) to the fiber optic network MAC instance for addressability in the fiber optic network;
assigning a second logical link identifier (LLID) to the cable MAC instance for addressability in the cable network;
forming a logical pairing of the first LLID and the second LLID; and
selectively filtering data traffic between the fiber optics MAC instance and the cable MAC instance using the logical pairing and a type of data traffic.

17. A data communication system, comprising:
a first data communications network in which data is transferred over a first physical medium using a first media access control (MAC) protocol;
a second data communications network in which data is transferred over a second physical medium using a second media access control (MAC) protocol; and
a combination apparatus that facilitates transfer of data between the first data communication network and the second data communication network using pairing of a first plurality of instances of the first MAC protocol on the first data communication side and a second plurality of instances of the second MAC protocol on the second data communication side, wherein the pairing is performed using information obtained during device discovery process.

18. The system of claim 17, wherein the first physical medium comprises an optical medium and the second physical medium comprises a coaxial cable medium.

19. The system of claim 17, wherein the combination apparatus further associates a MAC address for local management on the first data communication network side.

20. The system of claim 17, wherein the combination apparatus selectively filters data packets transferred between the first data communication network and the second data communication network.
